(19) United States
(12) Patent Application Publication
(10) Pub. No.: US 2025/0369465 A1
(43) Pub. Date: Dec. 4, 2025

(54) Anti-Rotate Binding Post

(71) Applicants: Shan Hemphill, Princeton, ID (US); Cole Hemphill, Princeton, ID (US)

(72) Inventors: Shan Hemphill, Princeton, ID (US); Cole Hemphill, Princeton, ID (US)

(21) Appl. No.: 19/206,841

(22) Filed: May 13, 2025

Related U.S. Application Data
(60) Provisional application No. 63/652,392, filed on May 28, 2024.

(51) Int. Cl. F16B 5/02

(52) U.S. Cl. CPC F16B 5/02

(57) ABSTRACT

An anti-rotate binding post attachment system for attaching a post-side component to a screw-side component, includes an internally threaded post and an externally threaded screw matching the internal threads of the post. The post includes a barrel having an open end, a head end and internal threads, and a head at the head end of the barrel, the head shaped as a polygon with at least 3 sides, wherein the polygon matches a corresponding engagement recess in the post-side component. The screw is inserted through openings in the screw-side component and in the post-side component to engage with the internal threads of the barrel.

### RELATED APPLICATIONS

This application claims priority to U.S. Provisional Patent Application Ser. No. 63/652,392, titled “Anti-Rorate Binding Post,” filed May 28, 2024, which is incorporated herein by reference.

### FIELD OF THE INVENTION

The present invention is directed to a fastener for securing two components to each other. More particularly, the present invention is directed to a binding post with applicability in holsters for firearms.

### DISCUSSION OF RELATED ART

Manufacturing processes involve attaching one component to another. One common attachment hardware is known as “Chicago Screws” or “binding posts,” which have origins in binding papers together. This hardware is formed of a hollow post and a screw. The post is placed on one side of the thermoformed part, which may be located on the inside of certain molded parts. The screw is then inserted through the other side of the thermoformed part and is seated by threading into the hollow post.

One such prior art attachment hardware is shown below in FIG. 1A and includes a hollow elongated post 102 with internal threading, which mates with a screw 104 having matching threading. Once these parts are tightly connected, they can be difficult to disassemble because rotating screw 104 will also cause post 102 to rotate. In particular, because the outside of the female portion may not be accessible, it cannot be secured against turning when torque is applied to the male screw. Separation between the parts is made even more difficult when thread lock is used to tighten the connection therebetween. Thus, if access to the female post is obstructed, such as when the post is located inside another component, separating the male screw from the female post becomes even more difficult because both portions will turn together.

An alternative to improve ease of separation is to create a molded thermoformed recess in the post in which a square nut as shown in FIG. 1B is positioned. This arrangement has the advantage of allowing the screw and nut to be more easily tightened or loosened from each other because the nut can resist rotation against the part being fastened. However, this arrangement has the disadvantage of lessened thread engagement because the relatively flat square nut can only accommodate several threaded turns. This lessened thread engagement is especially problematic in cases where a single length screw is used to attach parts of varying thickness; the risk is that the screw threading may not completely engage the entire nut threading, leading to a weak connection, or that the screw threads will extend beyond the square nut which may be undesirable for various reasons.

### SUMMARY OF DISCLOSURE

In accordance with an embodiment, an anti-rotate binding post attachment system for attaching a post-side component to a screw-side component is disclosed having a post and a screw. The post has a barrel having an open end, a head end and internal threads, and a head at the head end of the barrel and integrally formed therewith, the head shaped as a polygon with at least 3 sides, wherein the polygon matches a shape of a corresponding engagement recess in the post-side component. The screw has external threads matching the internal threads of the barrel, wherein the screw is inserted through openings in the screw-side component and in the post-side component to engage with the internal threads of the post.

In accordance with an embodiment, the internal threads of the barrel extend through the head, and the post is open at both ends.

In accordance with another embodiment, one or more spacers are inserted between the post-side component and the screw-side component so that openings in the one or more spacers align with openings in the post-side component and the screw-side component.

In accordance with still another embodiment, one spacer is inserted between the post-side component and the screw-side component, and the post is seated in the engagement recess so that the barrel extends away from screw-side component so that the screw is inserted through the head of the post so that the barrel of the post protects the screw threads.

Other objects and features of the present invention will become apparent from the following detailed description considered in conjunction with the accompanying drawings, in which same or similar components and elements are designated with the same numeral reference. It is to be understood, however, that the drawings are designed solely or purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE FIGURES

In the Figures:

FIG. 1A shows a prior art binding post.

FIG. 1B shows a prior art square nut.

FIG. 2 depicts an anti-rotate binding post, in embodiments.

FIG. 3 depicts another anti-rotate binding post, in embodiments.

FIG. 4A is a perspective top view of two components attached using an anti-rotate binding post, in embodiments.

FIG. 4B is a perspective bottom view of the two components of FIG. 4A.

FIG. 4C is a side view of the two components of FIG. 4A.

FIG. 4D is a cross-sectional view taken along line 4D-4D in FIG. 4C.

FIG. 4E is a detailed view of a portion of FIG. 4C.

FIG. 4F depicts bottom perspective, side and top perspective views of an anti-rotate binding post, in embodiments.

FIG. 5A is a perspective top view of two components attached using an anti-rotate binding post, in embodiments.

FIG. 5B is a top view of the two components of FIG. 5A.

FIG. 5C is a side view of the two components of FIG. 5A.

FIG. 5D is a cross-sectional view taken along line 5D-5D of FIG. 5C.

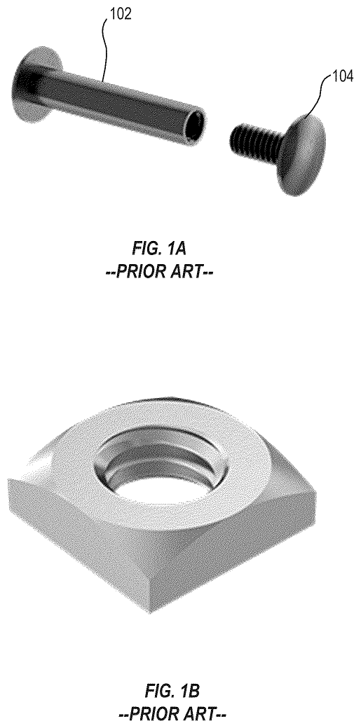

### DETAILED DESCRIPTION OF THE EMBODIMENTS

In accordance with the disclosed embodiments a binding post is described which incorporates desirable qualities of both the square nut and binding post into a single part, providing extended thread engagement and a head that can interface with a thermoformed part to more easily tighten or loosen the hardware. The improved binding post provides an enhanced way of attaching fastening hardware to parts with a molded-in recess. Other benefits include a minimum of intrusion into the interior space, positive fastener holding against rotation, and enhanced thread engagement. The binding post is easily installed without tools, and allows for its removal even when a non-permanent threadlocker is utilized.

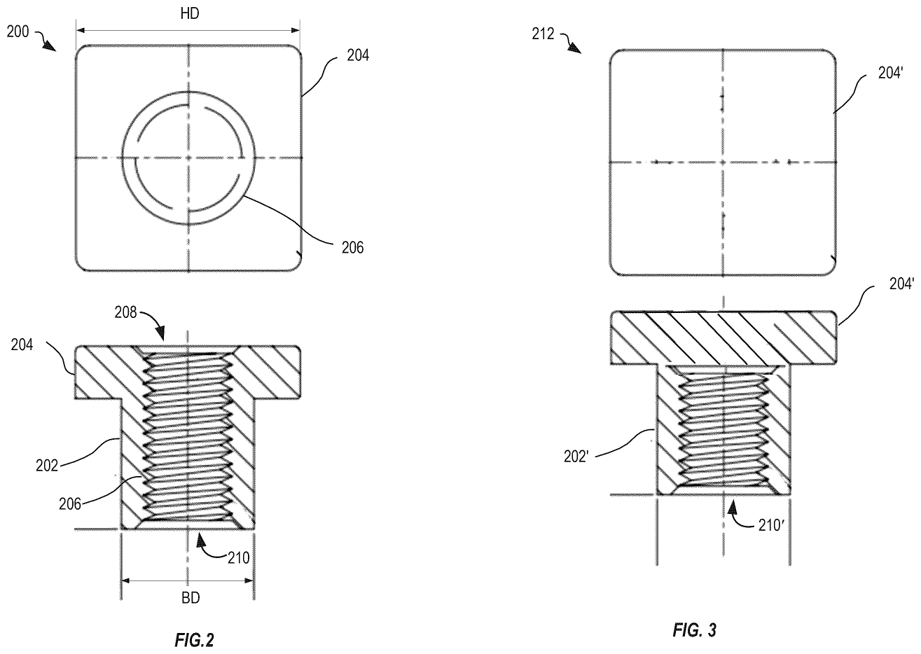

FIG. 2 depicts an anti-rotate binding post 200. Post 200 includes barrel 202 and head 204. Barrel 202 includes internal threads 206 with a smooth exterior. Internal threads 206 extend through both barrel 202 and head 204 such that post 200 includes both head end 208 and open end 210. Although head 204 is shown having a square shape, this is for purposes of illustration only. Head 204 may have the shape of any polygon having at least three sides, such as a triangle, pentagon, hexagon, etc. In embodiments, the largest dimension HD of head 204 is larger than the diameter BD of barrel 202.

FIG. 3 depicts another anti-rotate binding post 212. Post 212 is a variation of post 200 where internal threads 206 extend only through barrel 202′ but not head 204′. Barrel 202′ has an open end 210′ but is closed at the other end of barrel 202′ by head 204′. As described above for post 200, head 204′ may have the shape of any polygon having at least three sides.

For either post 200 or post 212, a screw (not shown) with external threads matching the internal threads of the barrel may be used to attach two components, which may be referred to as a post-side component and a screw-side component.

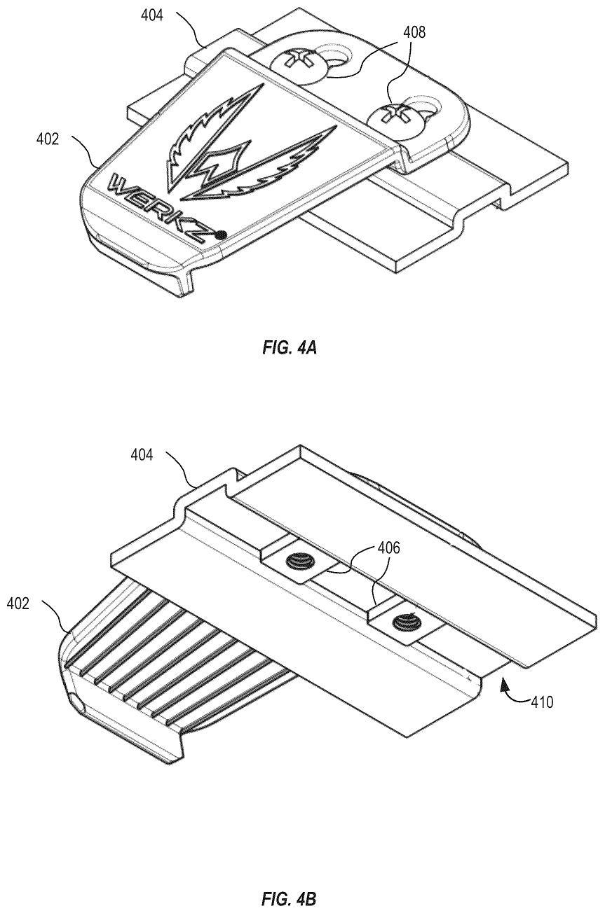

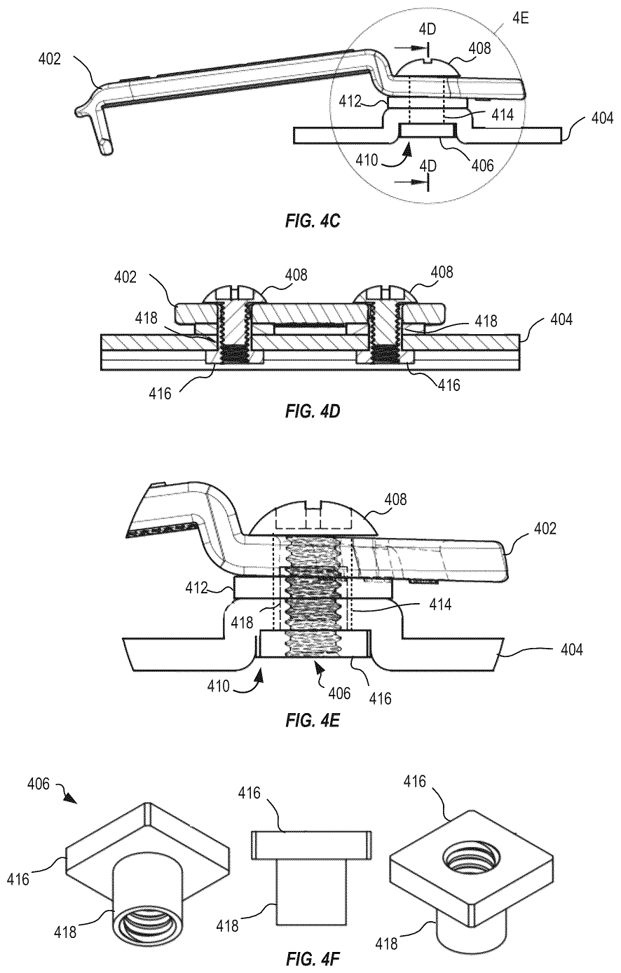

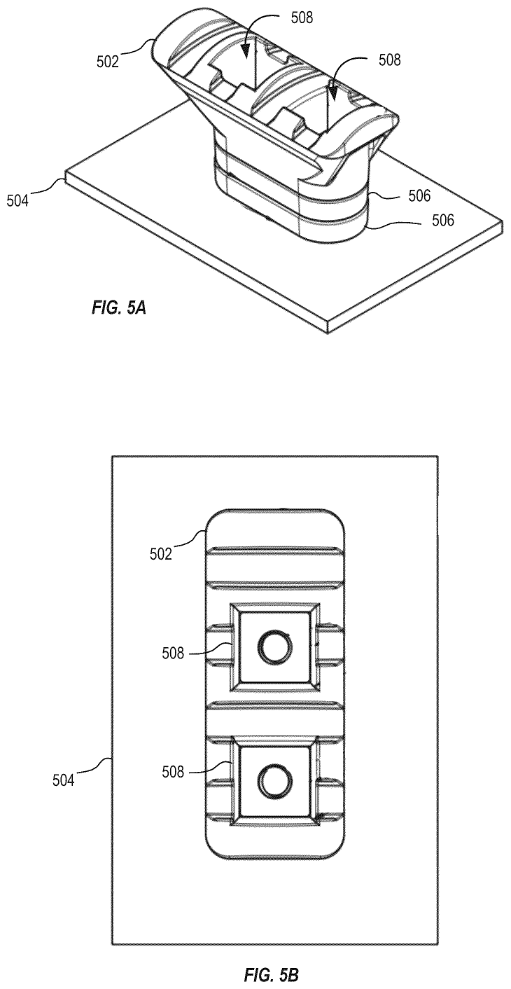

FIG. 4A is a perspective top view of two components attached to each other using an anti-rotate binding post. FIG. 4B is a perspective bottom view of the two components of FIG. 4A.

Specific components are shown herein but this is for purposes of illustration and principles disclosed herein may be applied to any two components suitable for attachment to each other. FIGS. 4A and 4B show a screw-side component 402 which may be a clip, in embodiments. Screw-side component 402 is attached to post-side component 404, which may be a belt or holster, by posts 406 and screws 408. Posts 406 are an example of post 200 or post 212. Although two posts are shown, any two components may be attached by one post or by three or more posts. Post-side component 404 includes an engagement recess 410 that receives the head of anti-rotate binding post 406. Engagement recess 410 is dimensioned to correspond to the largest dimension of the head to prevent the post from rotating when torque is applied to screw 408. As shown in FIG. 4B, engagement recess 410 is formed as a slot which engages with two opposing sides of the head of both of posts 406. In embodiments, engagement recess 410 may also be a series of individual recesses or bosses formed to correspond to the shape of the head of post 406.

FIG. 4C is a side view of screw-side component 402 attached to post-side component 404 by post 406 and screw 408. FIG. 4D is a cross-sectional view of the components of FIG. 4C taken along line 4D-4D. FIG. 4E is a detailed view of a portion of FIG. 4C. FIG. 4F depicts bottom perspective, side and top perspective views of an anti-rotate binding post. FIGS. 4C-4F are best viewed together in the following discussion.

A screw-side component is attached to a post-side component by post 406 and screw 408. Post 406 includes head 416 and barrel 418, which are examples of head 204 and barrel 202 of post 200. An optional spacer 412 (shown in FIG. 4E) is positioned between screw-side component 402 and post-side component 404. Each of screw-side component 402, post-side component 404 and optional spacer 412 includes an opening 414, represented by a dashed line, to allow passage of post 406 and screw 408. As shown in FIG. 4A, opening 414 may be a double hole or more than one opening may be provided in any component to allow flexibility of placement.

Attachments of components of varying thicknesses may be realized using the same hardware and disassembled more easily than with a standard binding post.

As a result of the square post head 416 being seated in an engagement recess 410 in post-side component 404, which interacts with one or more surfaces of the post head 416, applying torque to screw 408 will not impart rotating motion to post 406, thereby allowing the two components to be separated from each other.

### Description of Usage

Post-side component 404 includes an engagement recess 410 to engage with head 416 of anti-rotate binding post 406.

All parts to be attached have an opening 414 in which the screw 408 or anti-rotate binding post 406 may pass through.

The anti-rotate binding post 406 is inserted into opening 414 of post-side component 404.

Spacer 412 may optionally be inserted in between post-side component 404 and screw side component 402. Spacer 412 may also be inserted between post head 416 and post-side component 414, or between screw-side component 402 and the head of screw 408. In embodiments, spacer 412 may be made of neoprene to allow for retention adjustment.

Screw-side component 402 is then attached to post-side component 404 by threading screw 408) into anti-rotate binding post 406.

Screw 408 is then threaded into the binding post 406 which can then be tightened because head 416 of binding post 406 engages with the molded engagement recess 410 to prevent rotation while the screw is rotated. Applying torque to screw 408 to disengage it from post 406 will not impart rotating motion to post 406, thereby allowing the two components to be separated from each other.

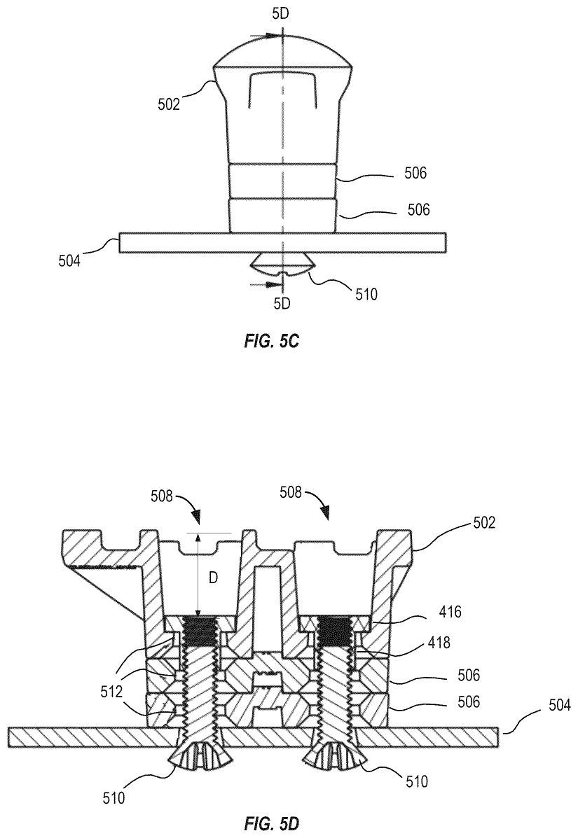

FIG. 5A is a perspective top view of two components attached using an anti-rotate binding post. FIG. 5B is a top view of the two components of FIG. 5A. FIG. 5C is a side view of the two components of FIG. 5A. FIG. 5D is a cross-sectional view taken along line 5D-5D of FIG. 5C. FIGS. 5A-5D may be used with post 406 of FIG. 4F and are best viewed together in the following description.

FIG. 5A shows a post-side component 502 for attachment to screw-side component 504 such as a belt or holster. Two spacers 506 are shown between post-side component 502 and screw-side component 504. In embodiments, no spacers, one spacer or multiple spacers may be used.

Post-side component 502 includes holes 508 formed in an upper surface and are square-shaped so as to engage with square heads 416 of binding posts 406. In embodiments, holes 508 may take any shape as long as it corresponds to the shape of head 416 so as to prevent rotation of head 416. As best shown in FIG. 5D, holes 508 have a depth D that is larger than the length of post 406 so that post 406 may be inserted with barrel 418 pointing towards screw 510 as shown, or head 416 may be seated in hole 508 so that barrel 418 points away from screw 510. This feature provides the benefit that different numbers of spacers 506 may be used with the same length of screw.

Each of post-side component 502, screw-side component 504 and spacers 506 includes an opening 512 to allow passage of barrel 418 and screw 510.

### Description of Usage

The part to be attached, post-side component 502, has a hole 508 formed as a square recess molded therein to engage the anti-rotate binding post.

All parts to be attached have an opening 512 in which the screw 510 or anti-rotate binding post 406 may pass through.

The anti-rotate binding post 406 is inserted into hole 508 of post-side component 502.

Zero, one, or more spacers 506 may optionally be inserted in post-side component 502 and screw-side component 504.

If no spacer is used, or one spacer is used, head 416 of anti-rotate binding post 406 is seated in hole 508 so that barrel 418 is extends away from the screw 510. This helps protect the screw threads that may otherwise protrude beyond the binding post.

If multiple spacers are used, the anti-rotate binding post barrel 418 is inserted through hole 508 so that barrel 418 extends towards screw 510. This helps ensure proper thread engagement as the screw may not be long enough to reach a simple square nut.

Screw-side component 504 is then attached to post-side component 502 by threading screw 510 into each anti-rotate binding post 406.

Screw 510 is then threaded into the binding post 406 which can then be tightened properly because head 416 of binding post 406 engages with hole 508 to prevent rotation.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An anti-rotate binding post attachment system for attaching a post-side component to a screw-side component, comprising:
a post comprising:
a barrel having an open end, a head end and internal threads; and
a head at the head end of the barrel and integrally formed therewith, the head shaped as a polygon with at least 3 sides, wherein the polygon matches a shape of a corresponding engagement recess in the post-side component; and
a screw comprising external threads matching the internal threads of the barrel;
wherein the screw is inserted through openings in the screw-side component and in the post-side component to engage with the internal threads of the post.

2. The anti-rotate binding post attachment system of claim 1, wherein the internal threads of the barrel extend through the head, and the post is open at both ends.

3. The anti-rotate binding post attachment system of claim 2, wherein the barrel is inserted through the engagement recess and the opening in the post-side component towards the screw-side component, and the head is seated in the engagement recess.

4. The anti-rotate binding post attachment system of claim 2, wherein the head is seated in the engagement recess and the barrel extends away from the screw-side component.

5. The anti-rotate binding post attachment system of claim 2, further comprising:
one or more spacers inserted between the post-side component and the screw-side component so that openings in the one or more spacers align with openings in the post-side component and the screw-side component.

6. The anti-rotate binding post attachment system of claim 5, wherein one spacer is inserted between the post-side component and the screw-side component, and the post is seated in the engagement recess so that the barrel extends away from screw-side component so that the screw is inserted through the head of the post so that the barrel of the post protects screw threads.

7. The anti-rotate binding post attachment system of claim 5, wherein a plurality of spacers are inserted between the post-side component and the screw-side component, and the post is seated in the engagement recess so that the barrel extends towards the screw-side component to ensure proper thread engagement with the screw.

8. The anti-rotate binding post attachment system of claim 1, wherein the post-side component is molded to form the corresponding engagement recess.

9. The anti-rotate binding post attachment system of claim 8, wherein the corresponding engagement recess is shaped so that at least two sides of head abut least two sides of the engagement recess to prevent rotation of the post when the screw is rotated.

10. The anti-rotate binding post attachment of claim 8, wherein the engagement recess has a depth larger than a length of the post.
